(19) United States
(12) Patent Application Publication
(10) Pub. No.: US 2013/0155692 A1
(43) Pub. Date: Jun. 20, 2013

(54) Interchangeable Décor Coverings

(71) Applicants: Betsy Federici, Weldon Spring, MO (US); Jamie Hathaway, Weldon Spring, MO (US)

(72) Inventors: Betsy Federici, Weldon Spring, MO (US); Jamie Hathaway, Weldon Spring, MO (US)

(21) Appl. No.: 13/713,546

(22) Filed: Dec. 13, 2012

Related U.S. Application Data
(60) Provisional application No. 61/570,402, filed on Dec. 14, 2011.

(51) Int. Cl. F21V 1/02; A47B 96/00

(52) U.S. Cl. CPC F21V 1/02; A47B 96/00
USPC 362/353; 29/428

(57) ABSTRACT

Disclosed is an interchangeable light fixture cover comprised of an upper frame, a lower frame, a transparent support for attaching the upper and lower frame together, a lamp shade covering material for covering the upper and lower frame, and an attachment means for securing the lamp shade to the frame. The cover includes a pair of magnet strips embedded therein, which can be attached to the upper and lower frame. The transparent support gives the impression that no vertical supports are being used, which provides an aesthetically pleasing appearance. Also disclosed is a method of decorating a room with matching décor coverings that each contains a magnet. The covers can be removed and replaced with covers of varying shape and design, which enables users to redecorate or update their décor without the need for purchasing completely.

### CROSS REFERENCE TO RELATED APPLICATION

This application claims the benefit of U.S. Provisional Application No. 61/570,402 filed on Dec. 14, 2011, entitled “Switch-IT.” The above identified patent application is herein incorporated by reference in its entirety to provide continuity of disclosure.

### BACKGROUND OF THE INVENTION

1. Field of the Invention

The present invention relates to a light fixture. More particularly, it pertains to an interchangeable magnetic cover for a light fixture, and a method of decorating a room with matching décor coverings that each contains a magnet.

A common type of artificial lighting found in modern homes is a light fixture, which is an electrical device used to create artificial light by use of an electric lamp. Light fixtures generally include a fixture body and a light socket, and are designed to hold a lamp and allow for its replacement. Fixtures may also include a switch for controlling the light. Modern light fixtures require an electrical connection to a power source. Permanent lighting may be directly wired, while moveable lamps include a plug for attachment to an electrical socket. Light fixtures typically use a lamp for lighting an area, such as an incandescent light bulb, compact fluorescent light bulb, or a light emitting diode (“LED”) bulb.

Conventional light fixtures additionally include a lamp shade, which is a fixture that covers the light bulb, and is designed to diffuse the light emitted therefrom. Lamp shades are generally conical or cylindrical in shape, and include open tops and bottoms. Light travels freely through the openings in the lamp to provide illumination in the location they are situated in. The material for the shade can be solid, which provides no light from the sides of the lamp, or can be constructed from a material that allows light to filter therethrough.

Beyond its practical purpose of diffusing light, significant emphasis is also given to the decorative and aesthetic features thereof. Lamp shades provide a decorative component to a location. As can be appreciated, lamp shades are available in a variety of shapes, colors, and styles. Many users spend significant amounts of time and attention ensuring that the lamp shades on a given light fixture are aesthetically pleasing with respect to the surrounding environment. If a room is redecorated, a user will oftentimes have to buy completely new lamps or lamp shades to complement the décor, which can be a significant expense.

In addition to redecorating a room for general use, individuals who enjoy decorating their homes for holidays may wish to utilize special lamp shades that include decorative components that emphasize a particular holiday. These lamp shades, however, are only used for a short period of time. When redecorating a room simply for a holiday, users not only have to buy new lamp shades, but also have to find space to store the old lamp shades for the season.

The present invention permits a user to efficiently and economically decorate and redecorate their lamp shades as desired. The device is comprised of an upper frame, a lower frame, a transparent support for attaching the upper and lower frame together, a lamp shade covering material for covering the upper and lower frame, and an attachment means for securing the lamp shade to the frame. The lamp shades are constructed in various shapes, and can be affixed to a variety of fixtures, such as a floor lamp, hanging lamp, wall sconce, or desk lamp. The lamp shade frame can be covered with decorative, interchangeable covers for different décors or holidays. The interchangeable covers are held in place with a variety of fasteners, such as magnets or clips. Also disclosed is a method of decorating a room with matching décor coverings for various articles of furniture, such as pillows, picture frames, blankets, curtains, and decorative wall panels. The furniture coverings each include a magnet, and are removably attached to the article of furniture. The coverings can be removed therefrom and replaced with coverings of varying design. This provides a user with a convenient and inexpensive way to add style and design elements to rooms by updating the appearance of the furniture without requiring replacement thereof.

### DESCRIPTION OF THE PRIOR ART

Devices have been disclosed in the prior art that relate to lamp shades that can be utilized when decorating a room. These include devices that have been patented and published in patent application publications. These devices generally relate to interchangeable lamp shades that include a frame and covering material. The following is a list of devices deemed most relevant to the present disclosure, which are herein described for the purposes of highlighting and differentiating the unique aspects of the present invention, and further highlighting the drawbacks existing in the prior art.

Specifically, U.S. Published Application Publication No. 2009/0225553 to Wu discloses a lamp shade that includes a top frame, a bottom frame, a lamp shade covering for covering the top frame, hook material at the top and the bottom frame, and loop materials at the lamp shade covering, which are detachably fastened to the hook materials to secure the lamp shade covering to the frame. The Wu device utilizes a plurality of radial connection rods spaced around the frame for connecting the top and bottom frames. These rods may be visible through the lamp shade covering, wherein the present invention utilizes a transparent material for connecting the top and bottom frames. This enables the use of translucent coverings without the rods being visible therethrough. In addition, the Wu device utilizes hook and loop fasteners for attachment of the lamp shade covering, whereas the present invention uses a magnet embedded into the lamp shade covering.

Similar to the Wu device, Glendmyer, U.S. Pat. No. 5,662,412, discloses a removable cover for an existing lamp shade having a base structure covered by an outer decorative material comprising a piece of decorative fabric conforming to the shape and size of the existing lamp shade to cover the outer decorative material. The device includes a pair of hook and loop strips on the top and bottom of the frame. The Glendmyer device provides a means of attaching a new decorative cover over top of an existing lamp shade. It does not, however, disclose a top and bottom frame attached with a transparent support, or utilize magnets on the lamp shade covering for attachment to the frame.

Bendit, U.S. Pat. No. 5,532,912, discloses a lamp shade dressing kit that secures decorative material of the user's choosing to a manufactured lamp shade in a non-destructive, visually non-obvious manner, permitting the subsequent removal or exchange of the material, when desired. This device, similar to Glendmyer, discloses a cover that attaches over top of an existing lamp shade. The Bendit device utilizes a plurality of hooks on the top and bottom of the lamp shade material for attachment to the frame. This device does not enable removal of the existing lamp shade material, but instead provides an additional cover for placement thereover.

Chambard, U.S. Pat. No. 4,212,052, discloses a lamp shade that comprises a cover fabricated from a generally rectangular sheet of flexible material to which composite fastener tape units are attached adjacent to the upper and lower edges thereof. The fastener tape is attached so that the fabric tape can be looped or folded about a conventional lamp shade ring, and the second pile-tape fastener tape that releasably engages with the first pile-type fastener tape to maintain the sheet of flexible material in a generally cylindrical configuration. The Chambard device uses the lamp shade material as an integral support structure for attaching the top and bottom frame. No support for connecting the top and bottom frame are provided, which limits the type of materials that can be used as a lamp shade covering.

Juang, U.S. Pat. No. 6,561,682, discloses a lamp shade structure that includes a frame body, a shade body and a circular frame. The frame body is embraced with multiple arch metal frames held together by multiple joints. The lamp stand is attached to the arch metal frame to stabilize the lamp base and light bulb. Hooks are integrally sewn to the shade body across the top and bottom end, where they are embedded with the circular frame and metal frames. The clips are spread evenly across the shade body edge to embrace the shade body. This device utilizes rods for attachment of the top and bottom frame, and utilizes a plurality of fasteners extending vertically along the lamp shade material. The Juang device does not disclose a means of magnetically attaching the lamp shade covering thereto.

Dunbar, U.S. Pat. No. 5,746,506 discloses a removable lamp shade cover and method therefore. The removable lamp shade cover is comprised of a tubular band of material having a top opening and a bottom opening, in which the band of material may be in any shape to correspond to the shape of an existing lamp shade. This device attaches a lamp shade cover over top of an existing lamp shade utilizing an elastic band attached to both the top and the bottom of an existing lamp shade. It does not provide a lamp shade frame with an upper and lower frame that are attached with a transparent support, or a removable covering that attaches with a magnetic means.

The devices disclosed in the prior art provide interchangeable lamp shades that enable a user to transform the appearance thereof. These devices, however, do not utilize a lamp shade frame with an upper and lower frame attached by a transparent support. The transparent supports utilized in the present invention enable the use of translucent material for the lamp shade covering without viewing the vertical supports that are contained in the prior art lamp shades. This provides an aesthetically pleasing shade that gives the impression that the lamp shade is being suspended without a support between the upper and lower frame.

In light of the prior art and the disclosed elements of the present invention, it is submitted that the present invention substantially diverges in design elements from the prior art. Consequently, it is clear that that present invention is not described by the art and that a need exists for interchangeable magnetic cover for a light fixture. In this regard, the instant invention substantially fulfills these needs.

### SUMMARY OF THE INVENTION

In view of the foregoing disadvantages inherent in the known types of interchangeable decorating systems now present in the prior art, the present invention provides a new interchangeable magnetic cover for a light fixture wherein the same can be utilized for providing convenience for the user when changing the aesthetic appearance of a light fixture cover.

It is therefore an object of the present invention to provide a new and improved interchangeable magnetic cover for a light fixture device that has all of the advantages of the prior art and none of the disadvantages.

It is another object of the present invention to provide a new and improved interchangeable magnetic cover for a light fixture comprised of an upper frame, a lower frame, a transparent support for attaching the upper and lower frame together, a lamp shade covering material for covering the upper and lower frame, and an attachment means for securing the lamp shade to the frame.

Another object of the present invention is to provide a new and improved interchangeable magnetic cover for a light fixture that includes a lamp shade frame that can be formed from a variety of shapes, including a circle, square, rectangle, oval, triangle, or other suitable shape.

Yet another object of the present invention is to provide a new and improved interchangeable magnetic cover for a light fixture that includes a metal strip on the upper and lower frame for attaching a magnetic lamp shade frame thereto.

Another object of the present invention is to provide a new and improved interchangeable magnetic cover for a light fixture with magnetic strips embedded into the upper and lower portions of the cover for attachment to the frame.

Still another object of the present invention is to provide a new and improved interchangeable light fixture cover that may be readily fabricated from materials that permit relative economy and are commensurate with durability.

A final object of the present invention is to provide a method of decorating a room with matching décor coverings that each contain a magnet.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the lamp shade frame.

FIG. 2 shows a view of the lamp shade cover secured to the frame with an attachment means.

FIG. 3 shows a close-up view of an alternate embodiment of the present invention, wherein the lamp shade cover is secured with clips.

FIG. 4 shows a perspective view an embodiment of the present invention, wherein the lamp shade cover is attached to a hanging light fixture.

FIG. 5a shows a perspective view of a pillow with a removable cover that is secured thereto with a fastening means.

FIG. 5b shows a perspective view of a picture frame with a removable cover that is secured thereto with a magnet.

FIG. 5c shows a perspective view of a blanket with a removable cover that is secured thereto with a magnet.

FIG. 5d shows a perspective view of a curtain with a removable cover that is secured thereto with a magnet.

FIG. 5e shows a view of a decorative wall panel with a removable cover that is secured thereto with a magnet.

FIG. 6 shows a perspective view of a room containing pattern coordinated décor items.

### DETAILED DESCRIPTION OF THE INVENTION

Reference is made herein to the attached drawings. Like reference numerals are used throughout the drawings to depict like or similar elements of the interchangeable light fixture cover. For the purposes of presenting a brief and clear description of the present invention, the preferred embodiment will be discussed as used for providing a cover for a light fixture. The figures are intended for representative purposes only and should not be considered to be limiting in any respect.

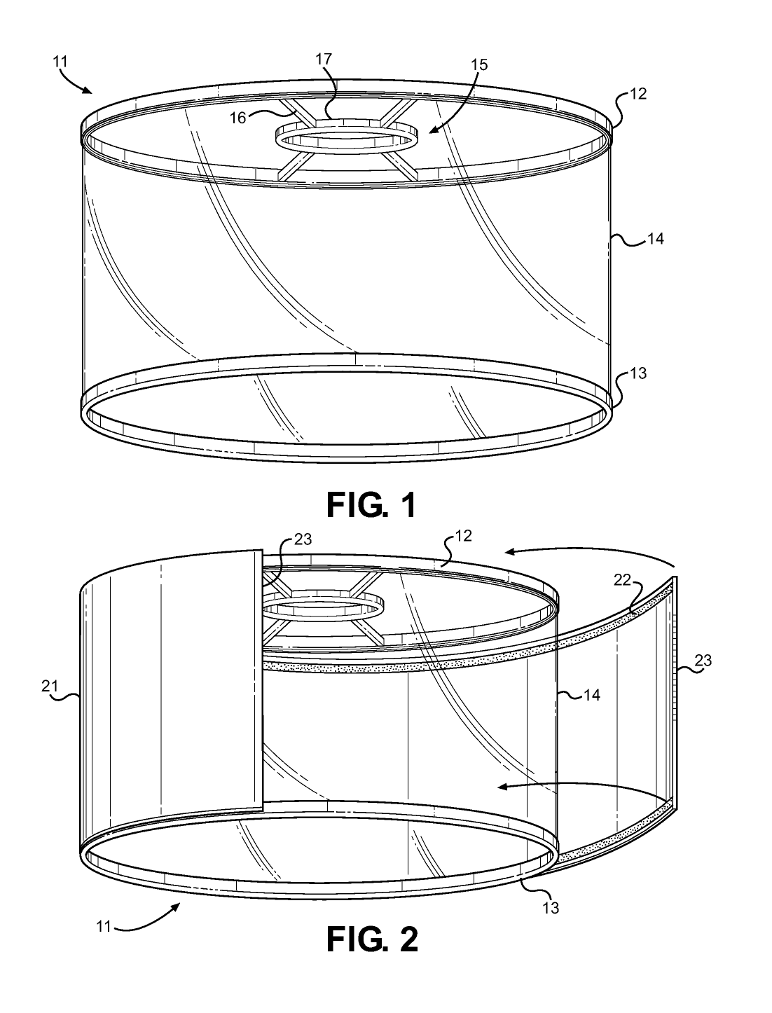

Referring now to FIG. 1, there is shown a view of the present invention, which is comprised of a lamp shade frame 11 having an upper frame 12, a lower frame 13, at least one transparent support 14 for attaching the upper and lower frame 12, 13 together, a lamp shade cover for covering the upper and lower frame 12, 13, and an attachment means for securing the cover to the upper and lower frame 12, 13. The upper and lower frame 12, 13 are held together by the transparent support 14, which provides a rigid connection therebetween. The upper and lower frames 12, 13, are configured one on top of the other.

The upper frame 12 includes a means of attaching the device to a conventional lamp. This is preferably accomplished with a lamp holder 15 that is comprised of at least one support 16 that extends radially towards the center of the frame 11. In a first embodiment, the support 16 is constructed of a transparent material that is similar in form and structure to the transparent support 14. In an alternate embodiment, the support 16 is formed from three or more equiangularly spaced supports that are made of metal or another suitable material. The center of the support 16 includes an aperture 17 for attachment to a conventional lamp. In an alternate embodiment, the support 16 can be positioned on the lower frame 13, which enables attachment of the lamp shade 11 to a floor lamp, desk lamp, or hanging sconce.

The lower frame 13 is preferably the same shape as the upper frame 12, and of a similar size. Alternately, the upper and lower 12, 13 frames can be formed of different sizes, thereby forming a frustoconical shape for the lamp shade. The upper and lower frame 12, 13 can be formed from a variety of shapes, such as a circle, square, rectangle, oval, triangle, or any other desired shape.

Referring now to FIG. 2, there is shown a view of the lamp shade cover 21 secured to the frame with an attachment means. The lamp shade cover 21 is designed to be secured around the frame 11, which is accomplished with an attachment means. In the preferred embodiment, the attachment means comprises a magnet strip 22 embedded in the cover 21 that can magnetically attach to the upper and lower frame 12, 13. The magnet strip 22 is preferably embedded into the upper and lower ends thereof. The upper and lower frames 12, 13 are formed with a flat band of ferrous metal, such as steel. This enables the cover 21 to be magnetically fastened to the upper and lower frame 12, 13.

The magnetic strip 22 can be embedded within the cover 21. Preferably, the magnetic strip 22 extends along the entire top and bottom of the cover 21. Alternately, the cover 21 can include sections of magnets spaced about the length thereof. The magnetic strip 22 can be secured to the cover 21 in a variety of ways, such as by sewing, gluing, or fastening. This enables the magnetic strip 22 to be hidden behind the cover 21 for an aesthetically pleasing appearance. With the strip 22 hidden behind the cover 21, it gives the impression that the cover 21 is providing support to the frame 11 instead of the transparent support 14, which is hidden from view.

The cover 21 is designed so that the terminal ends 23 touch each other when positioned on the frame 11. This ensures complete coverage thereof. Because the magnetic strips 22 are of the same dimension, the cover 21 can be reversibly positioned on the frame 11. This is useful for designs that can be viewed in more than one direction. The cover 21 can be constructed of a number of different material types, such as cotton, fabric, canvas, leather, nylon, or any other transparent, translucent, or opaque material.

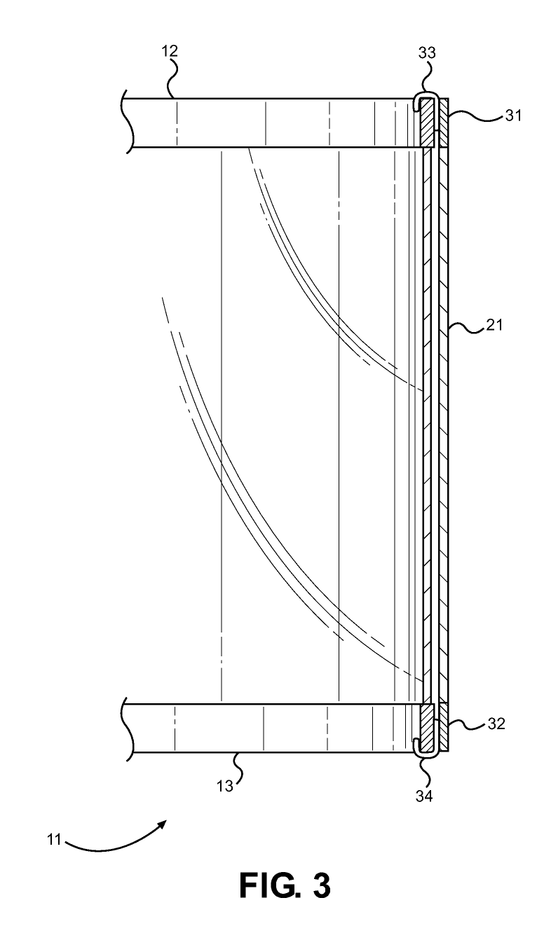

Referring now to FIG. 3, there is shown a close-up view of an alternate embodiment of the present invention. The lamp shade cover 21 can be secured to the lamp shade frame 11 with a variety of attachment means. The cover 21 can include an upper and lower band 31, 32 that extends around the top and bottom thereof, which corresponds to the upper and lower frames 12, 13. The bands 31, 32 can include an attachment means, such as an upper and lower clip 33, 34 to support heavier covers. The bands 31, 32 on the lamp shade cover 21 are aligned with the upper and lower frames 12, 13, and are secured in place, giving the impression that the two pieces are one, singular unit.

The clips 33, 34 are preferably a J-clip, and are designed to be fastened over the upper and lower frames 12, 13. The clips 33, 34 can be secured to the bands 31, 32, or can be molded with the bands 31, 32 as one piece. The user can attach the upper clip 33, the upper band 31, and then stretch the cover 21 down in order to attach the lower clip 32 to the lower band 34. This allows the cover 21 to be formed of stretchable materials, whereby the clips 33, 34 are stretched in order to attach to the upper and lower frames 12, 13. This causes the material forming the cover 21 to stretch, thereby giving a taught appearance.

Because the clips 33, 34 are designed to secure over the upper and lower frames 12, 13, the same frame 11 can be used with both magnetic and J-clip style covers. This provides a user with a variety of options for lamp shade covers. A user can install a magnetic cover onto the frame 11 for a period of time, and then remove and replace with a J-clip cover. This prevents the need for removing and replacing the frame 11 when different style covers are used on the same light fixture.

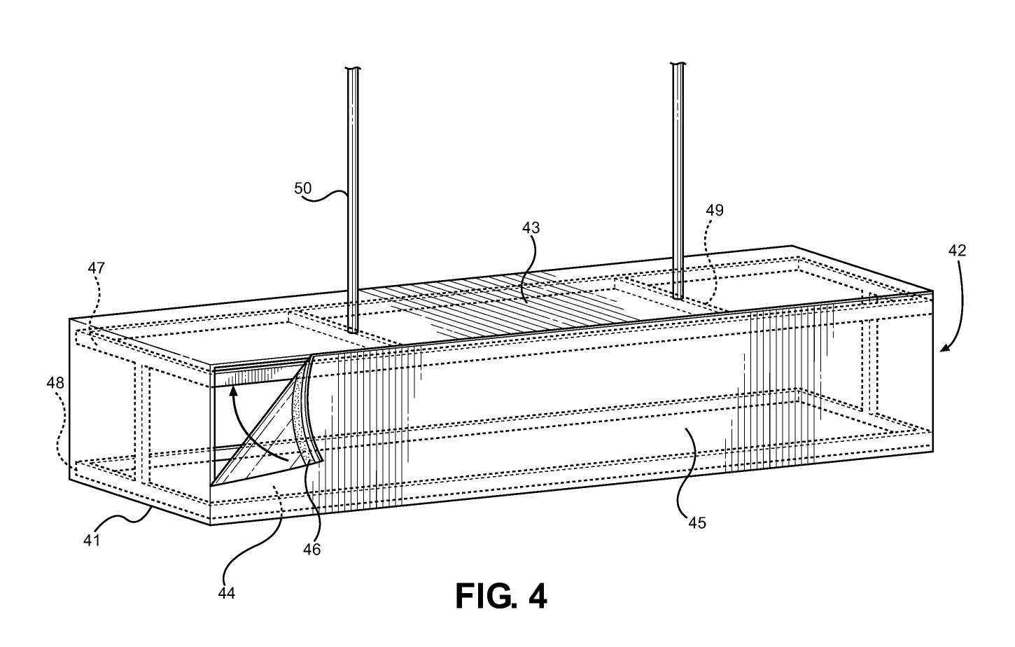

Referring now to FIG. 4, there is shown a perspective view of an alternate embodiment of the present invention, wherein the lamp shade cover 42 is attached to a hanging light fixture. The lamp shades can be affixed to a number of lamp fixtures, including a floor lamp, hanging lamp, wall sconce, or desk lamp. Additionally, the present invention can be constructed to cover a conventional hanging light fixture. In this embodiment, the frame 41 and cover 42 comprise create an enclosure, with an open space on the interior thereof for housing a light fixture. The light from within the frame 41 and cover 42 are diffused through the cover 42 and into the surrounding space. The upper and lower covers 43, 44 can be formed of a transparent or translucent material, while the sidewalls 45 can be made from an opaque material, which enables a majority of the light produced from the fixture to pass through the upper and lower covers 43, 44. This causes the upper and lower covers 43, 44 to act as a diffuser for providing the surrounding area with soft, diffused light. Alternately, the upper and lower covers 43, 44 can be formed of the same material as the sidewalls 45, which causes a uniform distribution of light on all sides.

The sidewalls 45 of the cover 42 can attach to the frame 41 with magnetic strips 46 embedded in the upper and lower frame 47, 48. The sidewalls 45 can be attached and removed as desired, which enables the user to change the aesthetic appearance of the light fixture. The sidewalls 45 can be separate from one another and removed individually, or can alternately be constructed as a single piece. When individually constructed, a user can attach sidewalls 45 of varying appearance to the frame 41 for a customized and unique design to the device. Sidewalls 45 of varying color, shape, and aesthetic appearance can be attached to each side of the frame 41 as desired.

The device further includes a means of hanging the frame 41, which is preferably accomplished with a pair of crossbars 49 that are attached to the upper frame 47. The crossbars 49 span the width of the frame 41, thereby providing a location for attachment of the frame 41 to a hanging cable 50 for suspension of the light fixture, frame 41, and cover 42.

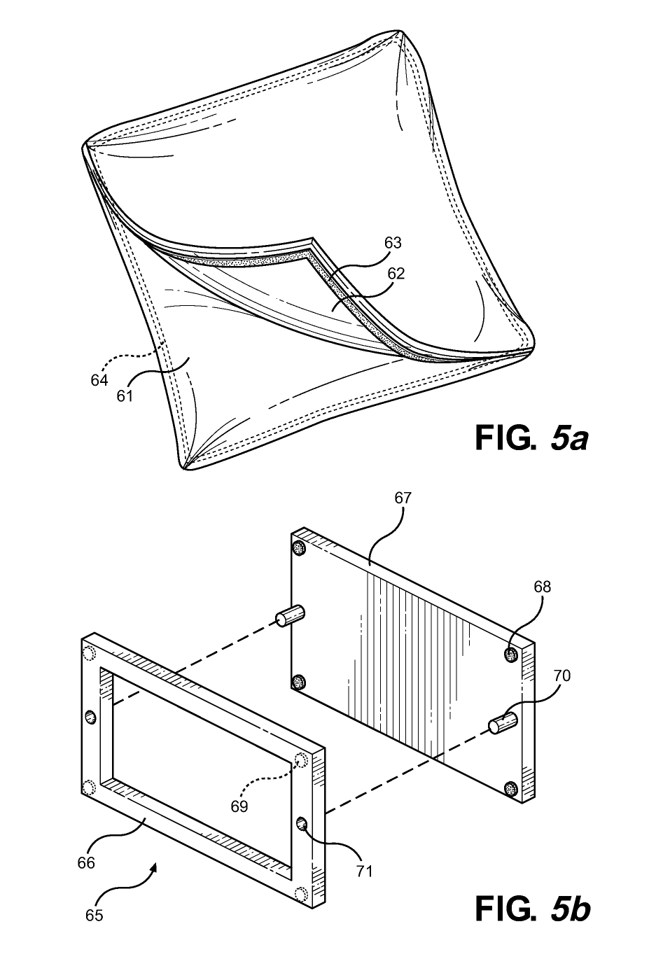

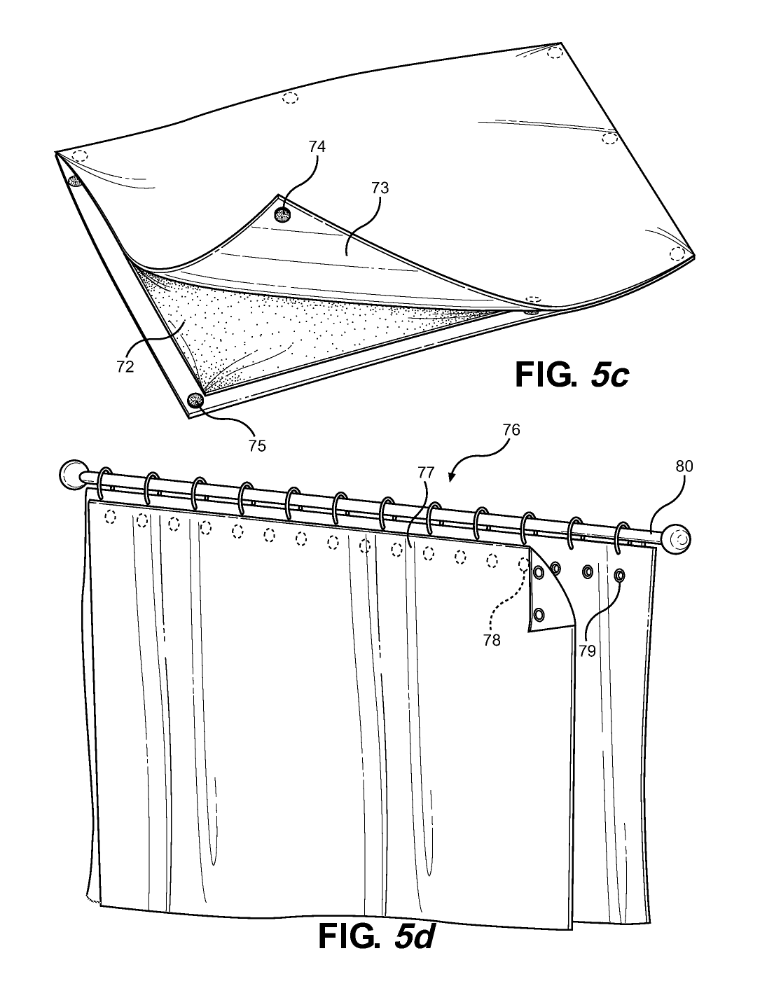

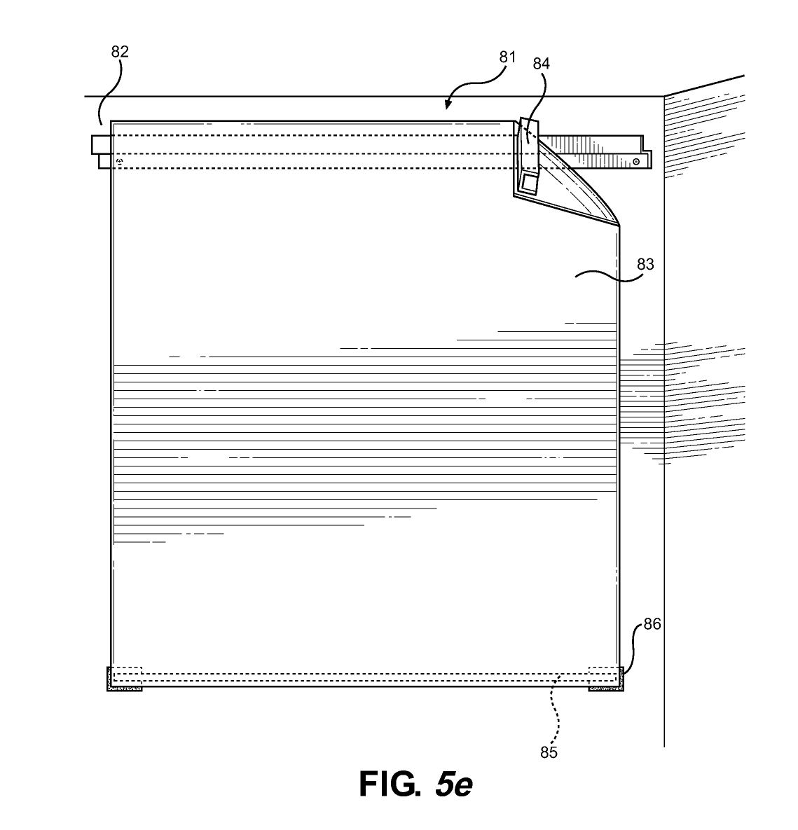

In addition to the lampshade, the present invention discloses a method of decorating a room with matching décor coverings for various articles of furniture, such as accent pillows, picture frames, blankets, curtains, and decorative wall panels that each contain a magnet. The furniture coverings are removably attached to the article of furniture with a fastening means, and can be removed therefrom and replaced with coverings of varying design. As shown in FIG. 5a, a pillow 61 can include a removable cover 62 that is secured in position with an attachment means, such as a magnetic strip 63 that surrounds the perimeter of the cover 62. The pillow 61 can include a ferrous metal strip 64 embedded in the perimeter thereof, which provides a means of attaching the magnetic strip 63 on the cover 62.

As shown in FIG. 5b, a picture frame 65 is also contemplated. The picture frame 65 includes a removable front cover 66 and a back plate 67. The cover 66 and back plate 67 can be attached with magnets 68 embedded in the back plate 67 that align with a ferrous metal 69 in the front cover 66. A peg 70 in the back plate 67 also aligns with an aperture 71 in the front cover 66. This allows a user to remove and replace the front cover 66, and replace it with covers of varying style.

As shown in FIG. 5c, the method of the present invention can further include a blanket 72 with a detachable and removable cover 73. Magnets 74 can be secured to the corners and perimeter of the cover 73 and attached to a corresponding ferrous metal 75. The cover 73 can be placed over the blanket 72 and removed as desired for changing the aesthetics thereof.

As shown in FIG. 5d the method of the present invention can additionally include a curtain 76. A curtain panel 77 can be attached to the curtain 76 with magnets 78 on the panel 77 that correspond to a ferrous metal 79 embedded within the curtain 76. The panel 77 extends to the end of the curtain 76, can be attached to one or both sides, and can be removed and replaced therefrom as desired. This enables a user to change the aesthetics of the curtain 76 while keeping the curtain 76 attached to the curtain rod 80.

In addition to lampshades, pillows, picture frames, blankets, and curtains, a decorative wall panel can include a removable decorative cover. As shown in FIG. 5e, a wall panel 81 can include an upper bracket 82, a pair of lower magnets 86 attached to a vertical surface, and a removable cover 83 that is secured to the bracket 82 and magnets 86. The upper section of the cover 83 attaches to the upper bracket 82 with a hook 84, while the lower section of the cover 83 includes an embedded ferrous metal bar 85 that attaches to the lower magnets 86. The cover 83 can be easily applied to and removed from the bracket 82 and bar 86 for changing the appearance thereof.

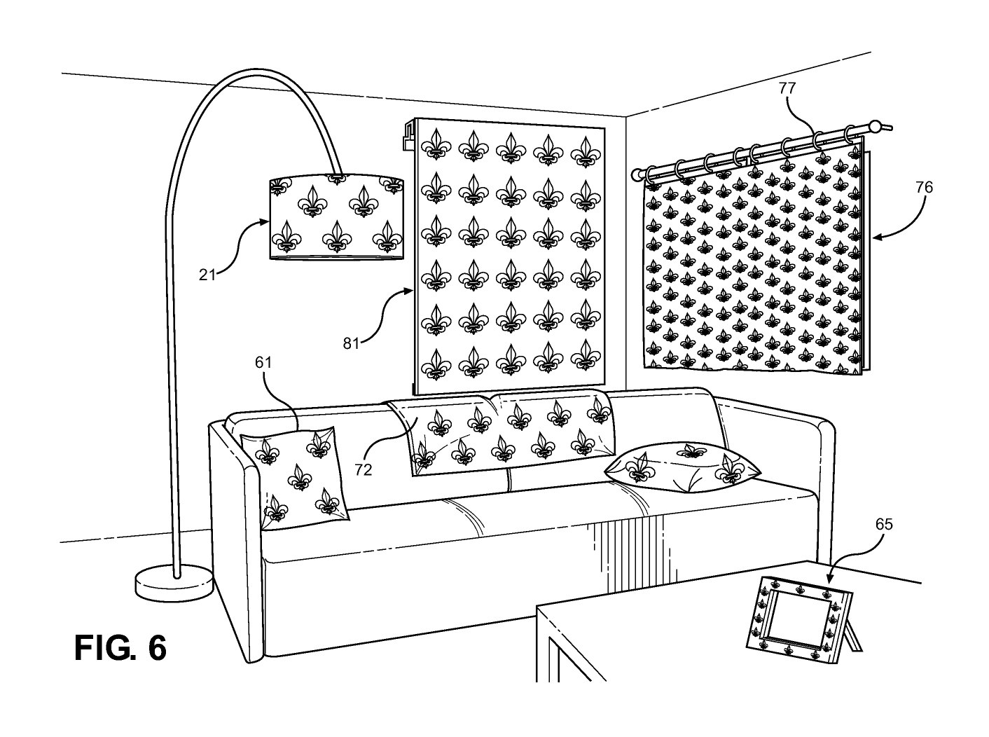

Referring now to FIG. 6, there is shown a perspective view of a room containing pattern coordinated décor items. A variety of items, such as a lampshade 21, pillow 61, picture frame 65, blanket 72, curtain 76, curtain valence 77 and decorative wall panel 81, each containing a pattern, can be coordinated in a room. Each of the décor items preferably includes a magnet contained therein, which enables attachment to a ferrous metal containing article of furniture. A user can select matching decorative coverings having a magnet therein, and attach the matching decorative coverings to at least two pieces of furniture from the group consisting of lampshades, accent pillows, picture frames, blankets, curtains, curtain valences and decorative wall panels, wherein each member of the group has integrated therein a ferrous metal for attachment to said magnet. The user can additionally select a second matching decorative covering set, remove the first matching decorative covering set from the pieces of furniture, and install the second set. This is particularly beneficial for changing the décor in a room based on the seasons, or for a particular holiday.

Overall, the device provides a means of changing the aesthetic appearance of a light fixture and a room. The lamp shade frame can be formed in a variety of shapes, and can be attached to any number of lamp fixture types. The matching decorative covering set can be used for redecorating or updating the décor in a room without the expense of purchasing completely new furniture to complement the new look. This is particularly useful for decorating for holidays, wherein a user would not only have to buy new lamp shades, picture frames, curtains, pillows, blankets and/or wall panels, but would also have to find space to store the items for the season.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lamp shade comprising:
an upper frame;
a lower frame;
at least one transparent support for attaching said upper and lower frame together;
a cover for covering said upper and lower frame, and said transparent support; and
an attachment means for securing said cover to said upper and lower frame.

2. The device of claim 1, wherein said upper frame includes a means of attachment to a conventional light fixture.

3. The device of claim 2, wherein said means of attachment further comprises at least one support extending radially towards the center of said frame.

4. The device of claim 3, wherein said support is constructed of a transparent material.

5. The device of claim 1, wherein said frame is constructed from a variety of shapes.

6. The device of claim 1, wherein said upper and lower frames are substantially the same size.

7. The device of claim 1, wherein said upper and lower frames are different sizes, thereby forming a frustoconical shape.

8. The device of claim 1, wherein said attachment means for securing said cover to said upper and lower frame further includes a magnet strip.

9. The device of claim 8, wherein said magnet strip is embedded into the upper and lower ends of said cover.

10. The device of claim 1, wherein said upper and lower frame are constructed with a flat band of ferrous metal that enables said cover to be magnetically attached thereto.

11. The device of claim 1, wherein said attachment means for securing said cover to said upper and lower frame further includes an upper and lower band containing a J-clip that is designed to be fastened over said upper and lower frames.

12. A lamp shade comprising:
an upper frame;
a lower frame;
at least one crossbar;
at least one transparent support for attaching said upper and lower frame together;
a cover for covering said upper and lower frame, and said transparent support that creates an enclosed space for a light fixture; and
an attachment means for securing said cover to said upper and lower frame.

13. The device of claim 12, wherein said cover is comprised of an upper cover, a lower cover, and at least one sidewall.

14. The device of claim 13, wherein said upper and lower covers are constructed of a transparent or translucent material.

15. The device of claim 12, wherein said sidewall includes at least one magnetic strip for attachment to said upper and lower frame.

16. The device of claim 15, wherein said sidewalls are separate from one another and can be removed individually.

17. The device of claim 15, wherein said sidewalls are constructed as a single piece.

18. A method of decorating a room, comprising the steps of:
selecting matching decorative coverings having a magnet therein; and
attaching said matching decorative coverings to at least two pieces of furniture from the group consisting of lampshades, accent pillows, picture frames, blankets, curtains, curtain valences and decorative wall panels, wherein each member of said group has integrated therein a ferrous metal for attachment to said magnet.

19. The method of claim 18, wherein said decorative wall panels comprise two or more patterns.
